(19) United States
(12) Patent Application Publication
(10) Pub. No.: US 2008/0014466 A1
(43) Pub. Date: Jan. 17, 2008

(54) Glass with scratch-resistant coating

(76) Inventors: Ronghua Wei, San Antonio, TX (US); Christopher Rincon, San Antonio, TX (US); James H. Arps, San Antonio, TX (US); David Kent Hartley, Renfrew, PA (US); Lance A. Cotton, Saxonburg, PA (US); David E. Hubert, Natrona Heights, PA (US); Paul Slovick, Butler, PA (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/485,639

(22) Filed: Jul. 11, 2006

(51) Int. Cl. B32B 9/00

(52) U.S. Cl. 428/698

(57) ABSTRACT

Glass having a diamond-like carbon (DLC) coating on top of an intermediate bonding layer of tin oxide, and a method for producing same. A glow-discharge method is used to apply the DLC coating. The glass may be chemically strengthened prior to applying the DLC coating.

### FIELD OF THE INVENTION

The present invention pertains to the field of glass, including glass used as transparent armor, and more particularly to scratch-resistant coatings for glass.

### BACKGROUND OF THE INVENTION

Wind-borne sand is known to cause glass windows to pit and develop a haze. Both sand and glass have silica as a primary constituent. So sand and common (uncoated) glass have a similar hardness, and for sand sliding over glass there is a high dynamic coefficient of friction. A wear resistant, low friction coating with a high level of visible light transmission would offer protection against scratch and abrasion, and would be especially desirable for transparent armor, where maintaining transparency is critical.

Diamond-like carbon (DLC) coatings have been shown to exhibit high hardness (1500 as a Vickers Hardness Number (HVN) and higher), a low coefficient of friction (typically less than 0.1), and are generally chemically inert. DLC as a term of art indicates an amorphous hydrocarbon polymer with carbon bonding largely of the diamond type instead of the usual graphitic bonding. More specifically, DLC refers to “forms of amorphous carbon and hydrogenated amorphous carbon containing a sizeable fraction of sp³ bonding,” as explained in “Deposition of diamond-like carbon,” by J. Robertson, Philosophical Transactions: Physical Sciences and Engineering, Col. 342, No. 1664, Thin Film Diamond (Feb. 15, 1993), pp. 277-286.

DLC is considered to be superior to polycrystalline diamond for sliding wear applications (abrasion resistance) since very smooth coatings can be deposited. These coatings are stable up to about 600° F. in air and generally resistant to ultraviolet (UV) degradation. While DLC coatings can often be as thick 2.5 to 5 microns (0.1-0.2 mils) for wear applications on fuel injectors, wrist pins, and forming tools, these coatings are not optically transparent. To enhance the scratch and sand abrasion resistance of glass without destroying its transparency, coatings in the range of less than a few hundred Angstroms (0.0001 mil) are required, and optically transparent DLC coatings for glass have been provided by the prior art, however the methods of application vary and result in final products differing in thickness of the DLC coating or coatings, how the DLC bonds to the glass, and whether any intermediate layers are used to enhance adhesion of the DLC to the glass or to desired properties, such as whether the final product is hydrophilic or hydrophobic. Importantly too, the methods differ in how practical it is to manufacture large quantities of DLC coated glass.

What is needed is a way to apply a DLC coating to a large surface area of glass reasonably quickly and inexpensively, and to have the DLC coating strongly bonded to the glass or an intermediate layer or intermediate coating that is in turn strongly bonded to the glass.

### SUMMARY

The invention provides glass having a DLC coating typically on one side. The glass has a layer of tin oxide or chemically similar oxide on its surface (typically on only one side) before the processing used to apply the DLC coating. The tin-oxide serves as an intermediate bonding layer; it is not removed during the processing used to apply the DLC coating.

The DLC may be applied according to the invention using a glow discharge technique in which many plates of tin-oxide coated glass are placed in a chamber and all coated at the same time.

Advantageously, the glass may include not only a tin-oxide coating serving as an intermediate layer, but may be chemically strengthened.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a schematic of a cross section of glass after application of a DLC coating, according to an advantageous embodiment of the invention.

FIG. 2 is a perspective drawing of glass arranged in a chamber for application of a DLC coating using a glow discharge, according to an advantageous embodiment of the invention.

FIG. 3 is a flow chart of a method of providing a DLC coating on glass, according to an advantageous embodiment of the invention.

### DETAILED DESCRIPTION

The invention coats glass panels, which may or may not be soda glass panels (i.e. including NaO), having an air side and an opposite side having a layer of tin oxide or chemically similar oxide, hereinafter the tin-oxide side. Such glass is usually called float glass, and sometimes soda lime glass. The thickness of the tin oxide layer is estimated to be at least 20 nm, and is typically from 20 nm to 50 nm. In some embodiments, the glass is chemically strengthened.

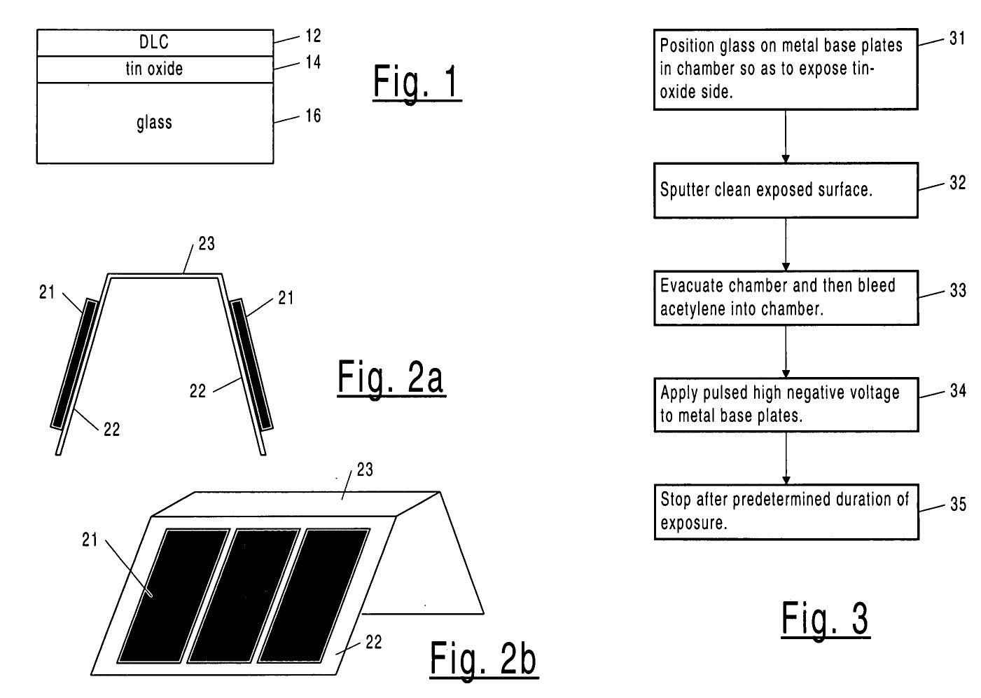

Referring now to FIG. 1, the invention provides a DLC coating 12 on top of a 20-50 nm thick tin-oxide layer 14 on glass 16. The DLC coating is typically (depending on the length of exposure to the feed gas) extremely thin, less than 100 nm, preferably less than 50 nm, and is highly transparent, with less than 2% visible light transmission loss. There is no DLC coating on the air-side of the glass with this method of application, since the air side of the glass faces the metal base plates.

Referring to FIGS. 2A-B and 3, in a first step 31 glass panels 21 are placed in a vacuum chamber (not shown) and arranged on metal base plates 22 so as to expose (and thus coat) the tin-oxide side (only). Then in a next step 32 the tin-oxide side of the glass is cleaned to remove organic contaminants, using an Oxygen sputter clean or Argon sputter clean. (The pressure in the chamber for the sputter cleaning is typically 15 millitorr.) Substantially all of the tin-oxide layer remains intact during the cleaning. This is known because, for one thing, if the DLC is applied to the air side after cleaning, the DLC coating comes off, but not when it is applied to the tin-oxide side (after cleaning). In addition, direct testing for the tin-oxide layer after cleaning confirms it is present to the same extent as before.

In a next step 33 the chamber is evacuated to a base pressure of approximately 10⁻⁵ Torr, and then acetylene (or a similar hydrocarbon gas) is injected (bleeded) into the chamber. The pressure in the chamber after the acetylene is again typically 15 millitorr. In a next step 34, a pulsed high voltage (2000-6000 Volts) is applied to the metal base plates supporting the panels to be coated, so as to impart to the base plates a pulsating negative voltage. The pulsed high voltage produces a so-called glow discharge plasma from the air and acetylene gas. The plasma is a mixture of electrons and positively-charged hydrocarbon ions, as well as excited neutral atoms and molecules in various energy states (electronic, vibrational, and rotational). The negative voltage on the base plates pulls the positive hydrocarbon ions out of the plasma. In a next step 35, the voltage is turned off after waiting a predetermined duration of time, depending on the DLC thickness wanted.

As shown in FIGS. 2A and 2B, the glass panels are oriented and positioned relative to the base plates so as to be struck by the positive hydrocarbon ions on the tin-oxide side as the ions are pulled toward the base plates. Also as shown in FIGS. 2A and 2B, special fixturing and mounting procedures are used, which limit the generation of so-called hollow cathode discharges that can result in a nonuniform coating with poor wear properties. Two metal base plates 22 are spaced approximately two to three feet apart and disposed almost vertically, with the top edges tilted toward each other at an angle of 5-10 degrees from vertical. (The hollow cathode discharge was observed to tend to occur when the plates are parallel, hence the tilt. Instead of the top ends tilting toward each other, the top ends can just as easily be tilted in the other direction, as long as there is a tilt away from parallel of at least approximately 10 degrees.) Spacing between the plates is maintained by a third plate 23 mounted across the top, although hollow cathode discharge is observed not to occur even without such a third plate, i.e. with the top edges of the two metal base plates in direct contact. Each metal base plate can accommodate several glass panels 21, depending on the size of the glass panels. (Panels on the same metal base plate are not a problem for hollow cathode discharge.) All metal base plates are electrically isolated from each other and can be biased individually for DLC coatings of different thickness.

By selective adjustment of key parameters such as gas composition, voltage, pulse frequency, and deposition time, the coating thickness (and darkness), hardness, and uniformity can be tailored to be most suitable for a given application.

In arriving at the invention, in addition to pure acetylene (C2H2) as the feed gas, a number of feed gas mixtures with acetylene were tested (including C2H2:SiH4, C2H2:H2) and also with methane (CH4) (including CH4:H2:Ar). Also, as mentioned, the efficacy of the tin-oxide layer was tested. Although other recipes tested satisfactorily, a recipe using pure acetylene as the feed gas at a pulsed high voltage of 4.1 kV and a pulse frequency of 500 Hz tested as particularly satisfactory. A typical flow rate for the acetylene is 60 sccm (standard cubic centimeters per minute). A duration of approximately 10-20 minutes yields a DLC coating of 50-100 nm, and in the testing performed, up to twenty square feet of glass surface was coated in 20 minutes. Also, as mentioned, when the air-side of the glass was coated, the DLC coating proved less environmentally stable, i.e. it came off.

Other recipes that appear satisfactory from the testing by the inventors include using pulsed voltages in the range of from 1500 volts to 6500 volts, pulse rates in the range of from 250 Hz to 2250 Hz, and feed rates of the hydrocarbon gas in the range of from 10 to 200 standard cubic centimeters per minute.

Although the use of glow discharge as described above is advantageous, the invention encompasses any method used for providing glass coated by DLC but having an intermediate layer of tin-oxide or other chemically similar metal oxide. Prior to the invention it was not appreciated that a tin-oxide layer provides advantageous environmental stability for at least some methods of application, and in particular those allowing high rates of production of DLC coatings.

As mentioned, in some embodiments of the invention the glass is chemically strengthened. Again, glass having an air side and a tin-oxide side is used. First it is annealed. Next it is preheated to 800° F. and then dipped into a molten bath of potassium salt at approximately 1050° F. (from 900° F. to 1100° F.). While in the salt the small alkali sodium ions in the glass near the surface are replaced with larger potassium ions. The depth of the ion exchange is believed to be only 64 microns as an average (and typically 20-100 microns) into the glass. This causes surface compression because of a wedging effect from the larger potassium ions. After 15-20 minutes, the glass is removed from the salt and allowed to cool.

Both sides of the glass are strengthened, the air side and the tin oxide side. The tin oxide layer is still present after the chemical strengthening, from direct testing for its presence. (Whether the potassium ions from the potassium salt bath simply migrate through the relatively thick tin oxide layer and into the glass, or whether some other phenomenon occurs is unknown to the inventors.)

The end result of the chemical strengthening is glass that is two to five times stronger than only annealed glass, and with much better optics than heat processed strengthened glass due to the temperatures used being 200° F. or more lower than what is used in heat processed strengthening.

The glass that is DLC coated can be either low-iron glass (ultra-clear glass) or so-called green glass. In case of glass used as transparent armor—i.e. so-called ballistic glass, the thickness is several multiples of the thickness of glass typically used in a non-armoring application. Ordinary (green) glass has a green tint when provided at such thickness. Low-iron glass does not. Both were found to receive a satisfactory DLC coating according to the invention, i.e. a coating that is environmentally stable.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A transparent panel, comprising:
a layer of glass having an air side and a metal-oxide side opposite the air side; and
a layer of diamond-like carbon coating on the metal-oxide side.

2. A transparent panel as in claim 1, wherein the metal oxide is tin oxide.

3. A transparent panel as in claim 2, wherein the tin-oxide layer is from 20-50 nm in thickness.

4. A transparent panel as in claim 1, wherein the glass includes a chemically strengthened region on the metal-oxide side, in which larger atoms have replaced sodium ions of the glass.

5. A transparent panel as in claim 4, wherein the chemically strengthened region is from 20-100 microns in thickness.

6. A method, comprising:
positioning and orienting a glass panel relative to a metallic base plate in a vacuum chamber so as to expose at least a target surface of the glass panel having a layer of tin oxide;
substantially evacuating the chamber;
introducing a hydrocarbon gas into the chamber and applying a pulsed high voltage to the base plate, thereby providing a diamond-like carbon coating of at least a portion of the surface having the layer of tin oxide.

7. A method as in 6, wherein the glass is float glass, having a tin-oxide side and an air side.

8. A method as in claim 6, further comprising, before placing the glass panel in the vacuum chamber, immersing the glass panel in a molten bath of potassium salt.

9. A method as in claim 8, wherein the temperature of the bath is in a range of from 900° F. to 1100° F.

10. A method as in claim 6, wherein the pulsed high voltage is in a range of from 1500 volts to 6500 volts.

11. A method as in claim 6, wherein the pulse rate is in a range of from 250 Hz to 2250 Hz.

12. A method as in claim 6, wherein the feed rate of the hydrocarbon gas is from 10 to 200 standard cubic centimeters per minute.

13. A method as in claim 6, wherein the hydrocarbon gas includes acetylene.

14. A method as in claim 6, wherein the hydrocarbon gas includes methane.

15. A method as in claim 6, wherein the metal oxide is tin oxide.

16. A method as in claim 15, wherein the tin-oxide layer is from 20-50 nm in thickness.

17. A method as in claim 6, wherein at least two glass panels are coated at the same time, and each is placed on a respective metal base plate, and the metal base plates face each other but are held away from parallel at a tilt angle of approximately at least 10 degrees.

18. A glass panel having a diamond-like carbon coating, as made according to the method of claim 6.
